(19) United States
(12) Patent Application Publication
(10) Pub. No.: US 2017/0232710 A1
(43) Pub. Date: Aug. 17, 2017

(54) MOLDED POLYMER AND METAL ARTICLES

(71) Applicant: DUREZ CORPORATION, NOVI, MI (US)

(72) Inventor: CHRIS F CIECHOSKI, NIAGARA FALLS, NY (US)

(73) Assignee: DUREZ CORPORATION, NOVI, MI (US)

(21) Appl. No.: 15/429,343

(22) Filed: Feb. 10, 2017

Related U.S. Application Data
(60) Provisional application No. 62/293,799, filed on Feb. 11, 2016.

(51) Int. Cl. B32B 15/098; B32B 15/18; B32B 27/42; B32B 3/26

(52) U.S. Cl. CPC B32B 15/098; B32B 3/263; B32B 15/18; B32B 27/42; B32B 2250/03; B32B 2307/546; B32B 2605/08

(57) ABSTRACT

There is provided a metal-organic composite which exhibits synergistic improvement in thermo-mechanical properties when compared with either of the components alone. The composites of this invention can be readily fabricated into various shapes by conventional molding processes including injection or compression molding. As a result, the composites of this invention find a variety of applications in fabricating a variety of three dimensional articles including automotive parts among others.

### CROSS REFERENCE TO RELATED APPLICATIONS

This application claims the benefit of U.S. Provisional Application No. 62/293,799, filed Feb. 11, 2016, which is incorporated herein by reference in its entirety.

### BACKGROUND OF THE INVENTION

Field of the Invention

The present invention relates to molded articles encompassing a combination of metal and polymeric materials. More specifically, the present invention relates to composites made from a plurality of polymeric layers molded over a plurality of metallic sheets. This invention also relates to methods of making such composite materials. The composite materials of this invention can be fabricated into a variety of three dimensional shaped articles, and thus find use in a variety of applications including automotive parts, such as brake pads, pistons, among other uses.

Description of the Art

There has been considerable interest in fabricating a metal composite for a variety of application as such materials provide significant advantages over metal alone. In general, the metal composites are expected to be significantly lighter than the metal itself, thus offering unique advantages in such applications as aerospace or automotive industry. In addition, metal composites are expected to be more corrosion resistant and thus offering applications where such properties are desired. The metal composites can be of various types in that the composite material used in conjunction with the metal can be an organic polymeric material such as thermoplastic or thermoset resin. In general, most thermoset and/or thermoplastic polymeric materials offer much higher flexural strength as well as tensile strength when compared with certain of the commonly employed metals while reducing the weight, reduced heat transfer, damping, just to name a few enhanced properties. In addition, polymeric materials can be readily fabricated by a variety of molding techniques including injection molding, compression molding, and the like.

However, in spite of the above enumerated advantages of a polymeric materials which make them versatile in certain applications, most of the polymeric materials do not exhibit mechanical strength as that of steel. There is also a need for ready fabrication of metal composites similar to that of polymeric materials. That is, there is a need to develop techniques which allows ready fabrication of metal composites simply by taking advantage of the flowabilty of polymeric materials at elevated temperatures which also improves the adhesion of the polymeric materials to non-polymeric materials such as metals. This results in ease of fabrication of a reinforced metal composites employing common fabrication methods used for the polymeric materials.

For example, U.S. Pat. No. 8,841,358 discloses ceramic composites having improved viscoelastic and rheological properties. Although such ceramic composites may provide certain enhanced viscoelastic properties, but are not suitable to replace metallic parts as they will not exhibit such high mechanical properties as attainable by metallic parts.

Accordingly, it is an object of this invention to provide a metal composite exhibiting synergistic properties.

It is also an object of this invention to provide processes for the fabrication of the metal composites as disclosed herein.

It is further an object of this invention to provide a metal composite which can be fabricated by conventional molding techniques to form a series of articles of industrial importance.

Other objects and further scope of the applicability of the present invention will become apparent from the detailed description that follows.

### SUMMARY OF THE INVENTION

Advantageously it has now been found that the metal composites of this invention can be readily made following the commonly used molding techniques. The composites of this invention exhibit synergistic properties in that the measured flexural strength of the composites are typically at least twice greater than that of the corresponding polymer alone.

Accordingly, there is provided a metal polymer composite comprising one or more layers of polymer sandwiched between one or more of a roughened metallic surface, wherein the composite exhibits at least fifty percent increase in flexural strength when compared with metal alone.

The composites of this invention find a variety of application including fabricating a number of parts for aerospace, automotive and other appliances among others.

### BRIEF DESCRIPTION OF THE DRAWINGS

Embodiments in accordance with the present invention are described below with reference to the following accompanying figures and/or images. Where drawings are provided, it will be drawings which are simplified portions of the invention provided for illustrative purposes only.

FIG. 1 illustrates a type of roughened textured surface of a metal which can be employed to form a metal composite embodiment of this invention.

FIG. 2 illustrates a typical dual sided metal composite embodiment of this invention.

FIG. 3 is a graphical illustration of the flexural strength of a number of metal composite embodiments of this invention fabricated under different conditions which are compared with the flexural strength of the corresponding polymer alone.

FIG. 4 is a graphical illustration of the flexural modulus of a number of metal composite embodiments of this invention fabricated under different conditions which are compared with the flexural modulus of the corresponding polymer alone.

### DETAILED DESCRIPTION OF THE INVENTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, the term “thermoset polymer or resin” is understood to mean a prepolymer or oligomeric material which cures irreversibly to form a polymeric material. The cure may be induced by heat, generally above 150° C. or higher, through a chemical reaction, or suitable irradiation. Such chemical reaction or irradiation can include a curing agent.

As used herein, the term “thermoplastic polymer or resin” is understood to mean a plastic material, polymer, that becomes pliable or moldable above a specific temperature and solidifies upon cooling. Most thermoplastics have a high molecular weight and generally can be reused after heating, cooling and/or molded into articles.

As used herein, the term “tensile modulus” is understood to mean the ratio of stress to strain and unless otherwise indicated, refers to the Young's Modulus measured in the linear elastic region of the stress-strain curve. Similarly, the term “tensile strength” is understood to mean the resistance of a material to a force tending to tear it apart, measured as the maximum tension the material can withstand without tearing. Tensile strength and tensile modulus are generally measured in accordance with ASTM method D638 using Type 1 tensile bar, which is made of the material being tested by machining, molding and/or any other acceptable methods as set out in ASTM D638 procedures.

As used herein, the term “flexural modulus or bending modulus” is understood to mean the ratio of stress to strain in flexural deformation, or the tendency for a material to bend. It is determined from the slope of a stress-strain curve produced by a flexural test, and uses units of force per area. Similarly, the term “flexural strength” is understood to mean the stress in a material just before it yields in a flexure test. Flexural strength and flexure modulus are generally measured in accordance with ASTM method D790 using a flex bar, which is made of the material being tested by machining, molding and/or any other acceptable methods as set out in ASTM D790 procedures.

As noted, the metal composites of this invention offer a number of advantages over the composites known in the art. More specifically, the composites of this invention can be readily formed by any of the known methods, such as for example, injection or compression molding by employing a textured metal surface and a thermoset or thermoplastic polymeric material. Advantageously, the metal composites of this invention exhibit synergistic properties in that the flexural and tensile properties are much enhanced when compared with the polymeric material alone. Even more importantly, the composites of this invention can be readily molded into a variety of articles by conventional molding methods, including compression molding. Thus, the composites of this invention find a variety of applications including in the fabrication of a variety of aerospace, automotive and other industrially important parts.

Accordingly, there is provided a metal polymer composite comprising one or more layers of polymer sandwiched between one or more of a roughened metallic surface, wherein the composite exhibits at least fifty percent increase in flexural strength when compared with metal alone.

Any of the metallic materials can be made into metal composites of this invention. By virtue of joining the metal with a polymer material the individual properties of the metal and/or the polymer is much enhanced in the composite, thus providing the synergy. Examples of metals that can be employed in forming the metal composites of this invention include without any limitation iron, copper, aluminum and an alloy in any combination thereof.

Any of the suitable alloys can be employed. One such commonly employed alloy that is suitable to form the composites of this invention include steel. Various forms of steel known to one skilled in the art can be employed. Such examples include without any limitation, stainless steel, crucible steel, carbon steel, spring steel, alloy steel, maraging steel, weathering steel, tool steel, and the like. Other non-limiting examples of such alloys include brass, bronze, solder, pewter, duralumin, phosphor bronze, amalgams, and the like.

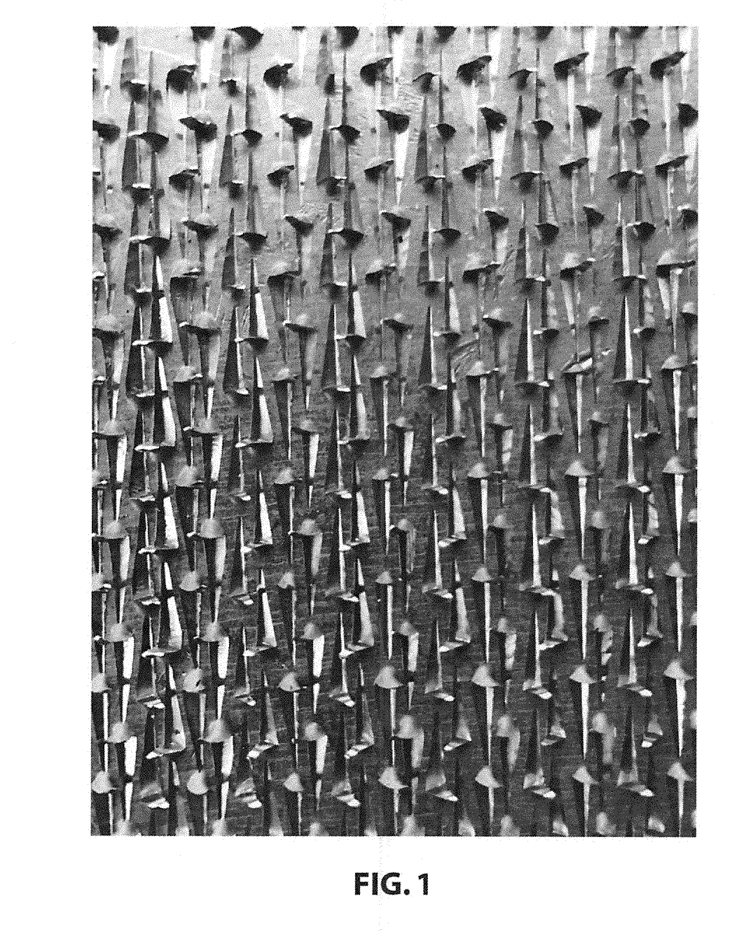

Advantageously, it has now been found that a roughened metallic surface improves the adhesion of the polymeric material to the roughened surface of the metal thus providing a composite of improved mechanical properties. The roughened surface can be in any form such that the polymeric material can adhere to such surface. In some embodiments the metal is roughened by a plurality of protrusions. Such protrusions can be in any form, such as for example, teeth on a surface, hooks on a surface, or any of such different forms of protrusions. An illustrative form of such roughened surface is provided in FIG. 1. However, any such similar shapes can be formed on the metal surface. Such roughening of the metal surface can be made by any of the methods known in the art such as for example by a suitable stamping method. For example, PCT Application No. WO 2014/087236 A1 describes a metallic surface containing a plurality of protrusions which are “piercing members” having a nail or pin like structure, or hooked or barbed structure raised on the surface of the material. Any of such roughened surface are suitable to be used in this invention to form the metal composites of this invention.

In another embodiment of this invention it has also been found that the composite of this invention can be formed by a metal surface which is partially oxidized. Any of the techniques known in the art can be employed to treat the metal surface to form such oxidized surface. One such example include treating the metal with an oxidizing agent such as for example acid, bleach, and the like. In some other embodiments the metal surface can also be treated with a suitable silane coupling agent which generally improves adhesion of polymer to the metal surface.

Any of the polymeric materials can be employed to form the metal composites of this invention. In some embodiments the composite of this invention contain a polymer which is a thermoplastic polymer.

Any of the thermoplastic polymer known to one skilled in the art can be used to fabricate the composite of this invention. Representative examples of thermoplastic polymers which can be employed in this invention without any limitation are selected from the group consisting of a condensation polymer and an addition polymer.

In another embodiment the composite of this invention contains a polymer which is a thermoplastic polymer selected from the group consisting of polyester, polyamide, polycarbonate, polyphenylene sulfide, polyether ketone, polyether ether ketone, polyolefin, polystyrene and polyacrylate.

In yet another embodiment of this invention the composite of this invention contain a polymer which is a thermoset polymer. Any of the known thermoset polymers can be used in the composites of this invention.

Non-limiting examples of a thermoset polymer is selected from the group consisting of a phenolic resin, a furan resin, an epoxy resin, an acryl resin, an urea resin and a xylene-type formaldehyde resin and any combination thereof. As noted, one of these resins may be used alone, or two or more of these resins may be used in combination.

In yet another embodiment the thermosetting resin containing the phenol resin is used in the metal composite of this invention. Again, any of the known phenol resins can be employed. Non-limiting examples of such phenolic resin is selected from the group consisting of novolak type phenol resin, an aralkyl type phenol resin, a dicyclopentadiene type phenol resin, a resol type phenol resin and a phenol type furan resin.

In some embodiments the metal composite of this invention encompasses a phenolic resin which is formed from a phenol selected from the group consisting of phenol, o-cresol, m-cresol, p-cresol, 2,3-xylenol, 2,4-xylenol, 2,5-xylenol, 2,6-xylenol, 3,4-xylenol, 3,5-xylenol, resorcinol, bisphenol A, bisphenol S, cresylic acid blends, p-tert-butylphenol, amylphenol p-octylphenol, p-nonylphenol, dodecylphenol, p-cumylphenol, catechol, resorcin, cardol, cardonol, cashew nutshell liquid and resorcinol, and a mixture in any combination thereof. Again, one or more of the aforementioned phenol can be employed in the phenolic resin of the metal composite of this invention. In some other embodiments two or more phenols are employed.

In yet some other embodiments the composite of this invention further encompasses a phenolic resin, which is formed from an aldehyde selected from the group consisting of formaldehyde, acetaldehyde, propionaldehyde, n-butyraldehyde, iso-butyraldehyde, glyoxal and furfural.

The composite of this invention further comprises one or more additives selected from the group consisting of a surface modifier, a surfactant, a curing agent, a silane coupling agent, an adhesion promoter, a lubricant, a ceramic filler, a glass fiber, mineral fillers, graphite, carbon fiber, an organic fiber, such as for example cellulose fiber, an inorganic fiber and clay, and the like. Any of the other commonly used fillers can also be employed.

Any of the silane coupling agent known to one skilled in the art can be employed in the metal composites of this invention. An example of such a silane coupling agent is a reactive silane coupling agent selected from one or more of an amino functional silane and epoxy functional silane.

In some embodiments the examples of silane coupling agents that are encompassed by the metal composites of this invention are selected from the group consisting of gamma aminopropyltriethoxysilane and 3-glycidoxypropyltrimethoxysilane.

In a further embodiment of this invention the composite of this invention encompasses a lubricant which is selected from the group consisting of silicone oil, paraffin wax, ethylenebisstearamide wax, Chembetaine, and a mixture in any combination thereof.

As noted, in some embodiments of this invention the composite of this invention encompasses a surfactant. Any of the known surfactant can be employed, including an ionic or a non-ionic surfactant.

The metal composites of this invention are generally formed by injection or compression molding but any of the other known methods to form such materials can also be employed. In general, the polymeric material is first compounded with any of the desirable filler material as described herein. Such compounding methods are commonly known in the art. For example, the compounding can be performed using a mixing bowl or an extruder, and or such similar techniques. A single crew or a twin screw extruder can be employed, and depending upon the type of polymer and the filler material employed the screw configuration can be designed so as to obtain optimum mixing of the polymer with the filler to obtain a homogenized filled polymeric material. Generally the compounding is carried out at an elevated temperature to obtain well dispersed filler material in the polymer matrix. Such elevated temperatures include heating the polymer to its fluid state, such as for example, above its glass transition temperature. In the case of thermoset polymers, the temperatures employed are generally lower than their curing temperature. After compounding, the compounds filled polymer material is extruded into strands and granulated.

Next, in a compression molding operation, a suitable roughened metal article is dispensed into a mold cavity. In order to form a dual sided metal composite the metal article is placed at the top and bottom of the mold cavity. If only a single sided metal composite is required then the metal article is placed on only one side of the mold cavity. In either of these situation the roughened surface is placed facing away from the mold wall and facing the cavity where polymer material is filled. Then the granulated organic polymer material which is either in its neat form or filled with other fillers as described herein is packed into the mold cavity. In order to obtain a metal composite having a plurality of metal-polymer reinforcement, the mold is packed alternatively with metal article and the polymer. Next the mold cavity is closed and heated to suitable temperature in the range of from about 100° C. to 300° C. depending upon the type of polymer employed under pressure for a suitable length of time in order to allow the polymer to cure fully under these conditions. Then the mold is opened to obtain the metal composites of this invention. The composite is then fabricated into desired shapes for the intended applications.

Similarly, in an injection molding operation, the procedures are substantially same as described above except that the polymeric material is heated and fluidic polymer material is then injected into the mold cavity in which the metal article is dispensed. Further, any of the other known molding techniques can also be employed to make the composites of this invention.

Accordingly, in some embodiments there is provided a single sided metal composite. In some other embodiments there is also provided a dual sided metal composite. In yet some other embodiments there is provided a metal composite having a plurality of layers of metal and the polymeric material as described herein.

### EXAMPLES (GENERAL)

The following examples illustrate a general procedure for carrying out various aspects of the invention as described herein. It should be understood, however, that the invention is not limited to the following examples.

### Example 1

### Compounding of the Molding Compound

In general, any of the thermoplastic or the thermoset polymeric material can be fabricated into a composite of this invention using any of the metallic parts that needs such reinforcement by following the procedures provided herein. The polymeric materials were compounded if necessary with any of the filler materials as disclosed herein using a twin screw extruder (coperion twin screw extruder) at a desirable temperature zones of 100 to 180° C. depending upon the type of polymer and filler materials employed. The compounded polymer and filler materials were extruded into granules before forming the metal composites of this invention as described in Example 2.

### Example 2

### Metal Composites

Testing plaques were molded using thermoset molding compound and 12 inch square by 0.020 inch thick metal reinforcements in a compression molding cavity of 0.25 inch depth using a 300 ton compression molding press. Dual sided plaques were molded by placing one reinforcement metal plaque into the chase of a mold heated to 170° C. in a “hooks up” orientation. FIG. 1 shows the type of metal plaque employed in this Example 2. The granulated thermoset molding compound from Example 1, which was preheated (using radio frequency (RF) heater) to approximately 100° C. was then packed over the metal plaque. The top reinforcement metal plaque was then placed over the granulated thermoset molding compound in a “hooks down” orientation and the mold closed to apply 2 tons per square inch of molding force, stops were used to ensure correct thickness.

A cure time of 5 minutes was allowed to ensure complete polymerization of the thermoset molding compound. After curing the mold was opened and the plaque set to cool in a fixture to reduce warpage. Cooled plaques were waterjet cut to the dimension of ASTM test bars. Then the test bars were post cured for 8 hours at 180° C. to dimensionally stabilize the parts before testing. Parts were tested using ASTM procedures for the testing required. Sample results included ambient testing as received and after extended oven aging.

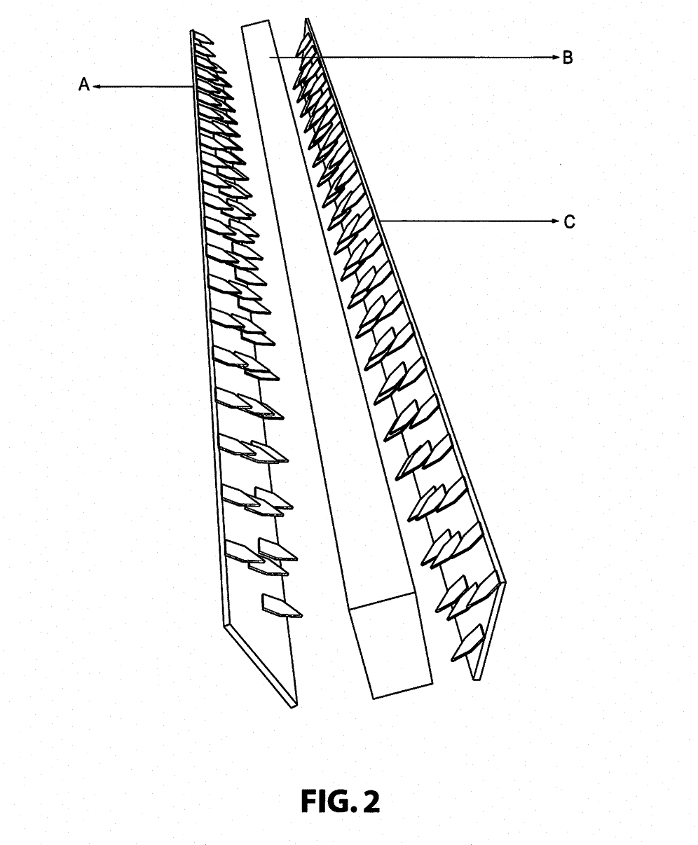

FIG. 2 shows a perspective view of a dual clad “sandwich” of metal composite made in accordance with the procedures set forth in Example 2. In FIG. 2, A is the top side of the metal reinforced composite of this invention where metal plaque with protrusions are facing the side of the polymeric layer B. C is the other metal plaque at the bottom of the composite with protrusions again facing towards the polymeric layer. Thus a metal composite of this invention can be formed using the procedures of Example 2.

### Examples 3-7

The procedure of Example 2 was substantially repeated in these Examples 3 to 7 and various dual sandwiched metal composites were formed using glass filled phenol formaldehyde resin as the polymer material and steel plates having protrusions substantially similar to that shown in FIG. 1. The molded samples in each of these Examples 3 to 7 were then post baked at 180° C. for different intervals of times as summarized in Table 1. The post baked samples were then tested for their flexural strength and modulus in accordance with ASTM D790 procedures.

TABLE 1

| Example No. | Hours post baked at 180° C. |
|---|---|
| Example 3 | 8 |
| Example 4 | 50 |
| Example 5 | 100 |
| Example 6 | 200 |
| Example 7 | 500 |

### Example 8

### Mechanical Property Measurements

In order to measure the mechanical properties of the metal composites of this invention several samples were made substantially following the procedures of Examples 3 to 7 except that the orientation of the protrusions in the metal were oriented differently in each of these situations. Each of the samples of Examples 3 to 7 were designated as follows: post baked for 8 hours, designated as PB-E8/180; 50 hours, designated as PB-E50/180; 100 hours, designated to as PB-E100/180; 200 hours, designated as PB-E200/180; and 500 hours, designated as PB-E500/180. Each of this set included parallel and perpendicular orientation of the metal protrusions of the top, “T” and bottom, “B” metal plaques, i.e., AT/AB, ET/EB, AT/EB and ET/AB, where “A” denotes protrusions are parallel to the flex bars and E denotes protrusions are perpendicular to the flex bars. The molded sample from Comparative Example 1 was used as a control. The flex bars cut in this fashion were in accordance with ASTM D790 for measuring the flex strength. This resulted in a total of 20 samples from Examples 3 to 7.

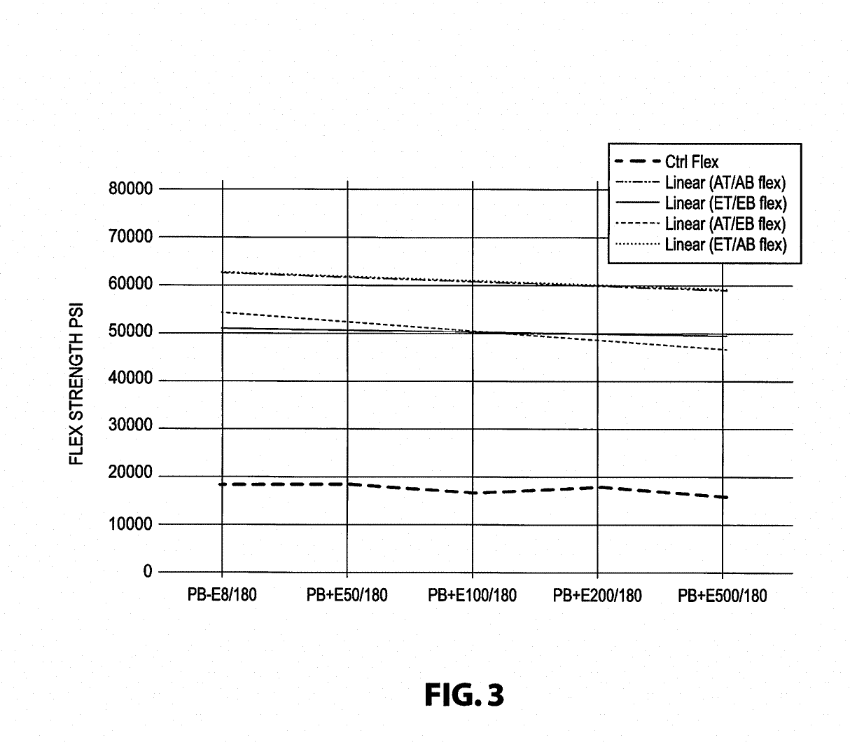

FIG. 3 shows the measured flexural strength of each of these samples. It is quite evident from this data that the measured flexural strength of all of the metal composites of Examples 3 to 7 is at least two times that of the control. That is, the flexural strength of the control is 20 kpsi, whereas the lowest flex strength measured for the metal composite is that of Example 3, designated PB-E8/180, which featured a flex strength of about 45 kpsi to 60 kpsi depending upon the orientation of the metal protrusions and typically the flex bars with metal protrusions parallel at the top and bottom (AT/AB) gave the highest strength.

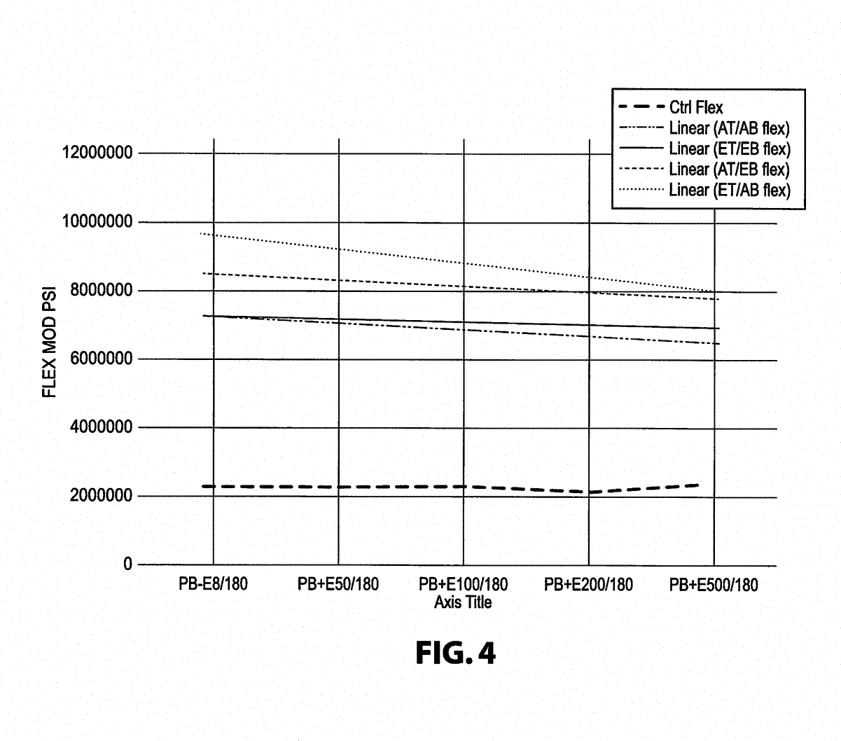

FIG. 4 further shows the measured flexural modulus of these samples. Again it is apparent that the flex modulus of the metal composites of this invention generally exhibit at least 3 fold increase in the flex modulus when compared with the control. Interestingly, the measured modulus is generally higher for flex bars molded with metal protrusions parallel at the top and perpendicular at the bottom (i.e., AT/EB).

### Comparative Example 1

The procedures as set forth in Example 2 were substantially repeated in this Comparative Example 1 except that no metal sheets were included in the compression molding cavity. Thus only the thermoset polymeric material was molded to form a polymeric molded article.

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A metal polymer composite comprising:
one or more layers of polymer sandwiched between one or more of a roughened metallic surface, wherein the composite exhibits at least fifty percent increase in flexural strength when compared with metal alone.

2. The composite according to claim 1, wherein the metal is selected from the group consisting of iron, copper, aluminum and an alloy in any combination thereof.

3. The composite according to claim 1, wherein the metal is steel.

4. The composite according to claim 1, wherein the metal is stainless steel.

5. The composite according to claim 1, wherein the metal is brass.

6. The composite according to claim 1, wherein the metal is roughened by a plurality of protrusions.

7. The composite according to claim 1, wherein the metal surface is partially oxidized.

8. The composite according to claim 1, wherein the polymer is a thermoplastic polymer.

9. The composite according to claim 1, wherein the polymer is a thermoplastic polymer selected from the group consisting of a condensation polymer and an addition polymer.

10. The composite according to claim 1, wherein the polymer is a thermoplastic polymer selected from the group consisting of polyester, polyamide, polycarbonate, polyolefin, polystyrene and polyacrylate.

11. The composite according to claim 1, wherein the polymer is a thermoset polymer.

12. The composite according to claim 1, wherein the polymer is a thermoset polymer selected from the group consisting of a phenolic resin, a furan resin, an epoxy resin, an acryl resin, an urea resin and a xylene-type formaldehyde resin and any combination thereof.

13. The composite according to claim 12, wherein the phenolic resin is selected from the group consisting of novolak type phenol resin, an aralkyl type phenol resin, a dicyclopentadiene type phenol resin, a resol type phenol resin and a phenol type furan resin.

14. The composite according to claim 12, wherein the phenolic resin is formed from a phenol selected from the group consisting of phenol, o-cresol, m-cresol, p-cresol, 2,3-xylenol, 2,4-xylenol, 2,5-xylenol, 2,6-xylenol, 3,4-xylenol, 3,5-xylenol, resorcinol, bisphenol A, bisphenol S, cresylic acid blends, p-tert-butylphenol, amylphenol p-octylphenol, p-nonylphenol, dodecylphenol, p-cumylphenol, catechol, resorcin, cardol, cardonol, cashew nutshell liquid and resorcinol, and a mixture in any combination thereof.

15. The composite according to claim 12, wherein the phenolic resin is formed from an aldehyde selected from the group consisting of formaldehyde, acetaldehyde, propionaldehyde, n-butyraldehyde, iso-butyraldehyde, glyoxal and furfural.

16. The composite according to claim 1, which further comprises one or more additives selected from the group consisting of a surface modifier, a surfactant, a curing agent, a silane coupling agent, an adhesion promoter, a lubricant, a ceramic filler, a glass fiber, graphite, carbon fiber, an organic fiber, an inorganic fiber and clay.

17. The composite according to claim 16, wherein the silane coupling agent is a reactive silane coupling agent selected from one or more of an amino functional silane and epoxy functional silane.

18. The composite according to claim 17, wherein the silane coupling agent is selected from the group consisting of gamma aminopropyltriethoxysilane and 3-glycidoxypropyltrimethoxysilane.

19. The composite according to claim 16, wherein the lubricant is selected from the group consisting of silicone oil, paraffin wax, ethylenebisstearamide wax, Chembetaine, and a mixture in any combination thereof.

20. The composite according to claim 16, wherein the surfactant is an ionic or a non-ionic surfactant.
